(19) United States
(12) Patent Application Publication
(10) Pub. No.: US 2023/0061664 A1
(43) Pub. Date: Mar. 2, 2023

(54) PLANETARY GEAR BOX

(71) Applicant: Rolls-Royce Deutschland Ltd & Co KG, Blankenfelde-Mahlow (DE)

(72) Inventor: Maximilian PRÖLSS, Berlin (DE)

(21) Appl. No.: 17/888,812

(22) Filed: Aug. 16, 2022

(30) Foreign Application Priority Data
Aug. 26, 2021 (DE) 10 2021 122 146.3

(51) Int. Cl. F16H 57/04; F16H 57/08; F02C 7/36; F02C 7/06; F16C 33/10

(52) U.S. Cl. CPC F16H 57/0471; F02C 7/06; F02C 7/36; F16C 33/1045; F16H 57/08; F16H 57/043; F16H 57/0427; F05D 2260/40311

(57) ABSTRACT

A planetary gearbox has a sun gear, planet gears, a ring gear and plain bearing pins. A plain bearing pin is arranged in a respective planet gear, wherein the plain bearing pin and the planet gear form a lubricated plain bearing which includes a plain bearing gap, and on its contact face, the plain bearing pin forms a feed pocket which is configured to receive oil and output it to the plain bearing. On its contact face, the plain bearing pin forms an additional feed pocket which is configured to receive oil and output it to the plain bearing, is spaced from the feed pocket in the circumferential direction, and is connected to the feed pocket such that oil from the additional feed pocket can flow on the contact face of the plain bearing pin to the feed pocket.

This application claims priority to German Patent Application DE102021122146.3 filed Aug. 26, 2021, the entirety of which is incorporated by reference herein.

The invention concerns a planetary gear box according to the preamble of Patent Claim 1 and to a gas turbine engine having a planetary gear box of this kind.

There is a known practice of coupling a gear fan engine to a turbine shaft via a planetary gear box, wherein the planetary gear box receives an input from the turbine shaft and outputs drive for the fan so as to drive the fan at a lower rotational speed than the turbine shaft. The planetary gear box comprises planet gears, which are driven by a sun gear and which revolve in a ring gear. Plain bearing pins are arranged in the planet gears, each pin forming a plain bearing with a respective planet gear and being connected to a planet carrier. The planet carrier is coupled to a drive for the fan. Such a planetary gear box is known from US 2019/162294 A1, for example.

It is furthermore known to form a feed pocket on the outside of the plain bearing pins of a planetary gear box, wherein said feed pocket is filled via oil feeds with oil which lubricates the plain bearing between the plain bearing pin and the planet gear. A plain bearing gap is present in the plain bearing between the plain bearing pin and the planet gear, the gap height of which varies in the circumferential direction. This is because, during operation of the planetary gear box, because of the rotational movement of the planet gears and the interaction between the toothing of the planet gear and the ring gear, the acting load reaches a maximum at a specific circumferential angle. In particular, the plain bearing gap has a gap height which converges in the circumferential direction, reaches a minimum and then diverges. Fresh oil entering a feed pocket heats up in the convergent region of the plain bearing gap and reaches its maximal temperature after the minimum of the gap height. The behaviour is such that hot oil accumulates in the axial centre of the plain bearing gap in the divergent region. As a result, the plain bearing is not adequately cooled in this region because of the accumulated hot oil. The problem therefore exists that the oil overheats in the divergent region of the plain bearing gap and forms temperature peaks which prevent a reliable cooling of the plain bearing.

Accordingly, the invention is based on the object of providing a planetary gear box with planet gears and plain bearing pins in which temperature peaks of the oil in the plain bearing gap are at least largely avoided.

This object is achieved by means of a planetary gear box having the features of Patent Claim 1, a plain bearing having the features of Patent Claim 19, and a gas turbine engine having the features of Patent Claim 20. Refinements of the invention are indicated in the dependent claims.

Accordingly, in a first inventive aspect, the present invention concerns a planetary gear box which comprises a sun gear, a plurality of planet gears, a ring gear and a plurality of plain bearing pins. The sun gear rotates about a rotational axis of the planetary gear box which defines an axial direction of the planetary gear box. The plurality of planet gears is driven by the sun gear and engages with the ring gear. The plain bearing pins each have an external contact face. A plain bearing pin is arranged in each planet gear, wherein the plain bearing pin and the planet gear form a lubricated plain bearing which comprises a plain bearing gap. On its contact face, the plain bearing pin forms a feed pocket which is provided and configured to receive oil and output it to the plain bearing.

It is provided that on its contact face, the plain bearing pin furthermore forms an additional feed pocket which is also provided and configured to receive oil and output it to the plain bearing. The additional feed pocket is here spaced from the feed pocket in the circumferential direction and is connected to the feed pocket such that oil from the additional feed pocket can flow on the contact face of the plain bearing pin to the feed pocket.

The invention is based on the concept of providing an improved cooling of the plain bearing by means of oil which is supplied to the plain bearing gap via an additional feed pocket, wherein the additional feed pocket is arranged spaced from the feed pocket in the circumferential direction. The oil provided via the additional feed pocket displaces the hot oil already present in the plain bearing gap from the feed pocket towards the axial ends of the plain bearing pin, and cools the plain bearing gap or plain bearing pin and planet gear. Fresh oil is also effectively distributed over the circumference of the plain bearing, which reduces the quantity of oil required and increases the efficiency of the gear box.

The present invention improves the performance and reliability of the plain bearing in a “flexible” environment by means of a new pocket configuration with two connected feed pockets. This achieves a substantial fall in the temperature level during operation, which increases the robustness and reliability of the bearing and leads to a higher load-bearing capacity and greater efficiency of the gear box.

In operation, the plain bearing gap has a gap height which varies in the circumferential direction. Thus, in the circumferential direction, the plain bearing gap comprises a convergent region, a minimal gap height and a divergent region. An embodiment of the invention provides that the additional feed pocket is formed in the divergent region of the plain bearing gap. The arrangement of the additional feed pocket in the divergent region of the plain bearing gap allows, in a particularly efficient fashion, an improved cooling and the avoidance of temperature peaks, since the oil has the highest temperature in the divergent region after the minimum of the gap height. This allows the oil in the divergent region to emerge to a substantial extent at the axial ends of the plain bearing gap, where it can be discharged without being conveyed back to the feed pocket in which it would displace fresh cool oil.

An embodiment provides that the additional feed pocket is formed in the circumferential direction in an angular region between 40° and 60° behind the greatest circumferential angle in the plain bearing pin which corresponds to a minimal gap height, i.e. shortly after the minimal gap height, so that heated oil is rapidly displaced and replaced by fresh oil. The circumferential angle in which the gap height is minimal may vary depending on the loads acting on the bearing. In the context of this variation, the greater circumferential angle corresponding to a minimal gap height is the circumferential angle which has the greatest distance from the feed pocket in the circumferential direction and is associated with a minimal gap height.

If, as is the case in some embodiments of the invention, the minimum of the gap height of the plain bearing gap is formed in an angular region between 170° and 210° away from the feed pocket, the additional feed pocket is thus formed in an angular region between 250° and 270° in some embodiment variants. It is pointed out that the feed pocket is formed in the plain bearing pin, in the circumferential direction, in the transition between the divergent region and the convergent region, and its position on the circumference of the plain bearing pin defines the 0° position of the circumferential direction, wherein the precise definition is that the centre line of the feed pocket defines the 0° position of the circumferential direction.

An embodiment of the invention provides that the additional feed pocket is connected to the feed pocket via a circumferential groove extending in the circumferential direction. It may be provided that the circumferential groove is formed centrally in the plain bearing pin with respect to the axial direction, i.e. at the same distance from both axial ends of the plain bearing pin. The cool oil entering the additional feed pocket is conducted into the additional pocket via the circumferential groove between the additional pocket and the feed pocket, without undergoing substantial heating. The circumferential groove here minimises a heat development in the oil attributable to shear forces. Further oil entering the additional pocket directly is added to the additional pocket, and the two oil streams mix before being transported in the direction of the convergent region.

According to an embodiment, the feed pocket and/or the additional feed pocket are formed so as to be rectangular in an unrolled view from above. A rectangular form of the feed pocket or additional feed pocket is simple to produce and allows the defined output of oil into the plain bearing on the long sides of the rectangular pockets. The transition to the regions of the contact face of the plain bearing pin, in which the feed pocket or additional feed pocket are not formed, may here be constant and free from edges.

It may furthermore be provided that the feed pocket and the additional feed pocket are formed centrally in the plain bearing pin with respect to the axial length of the plain bearing pin. They may have the same axial length or alternatively different axial lengths. They may also have the same width in the circumferential direction or alternatively different widths in the circumferential direction.

In one embodiment, the axial length of the feed pocket and the axial length of the additional feed pocket are dimensioned such that they correspond to at least 50%, in particular at least 70% of the axial length of the plain bearing gap. A large axial length of the feed pocket and additional feed pocket ensures that the plain bearing undergoes effective lubrication and cooling over its axial length.

An embodiment of the invention provides that the planetary gear box has a first and a second oil supply system for the provision of lubricating oil, which are independent of one another. Redundant lubricating oil systems are used for safety reasons. It is provided here that the first oil supply system supplies oil only to the feed pocket, and the second oil supply system supplies oil only to the additional feed pocket. The two oil supply systems thus each only supply oil to one of the pockets. In the case of failure of one oil supply system, the other oil supply system and the associated pocket provide a lubrication of the plain bearing. By assigning each oil supply system to a respective one of the two pockets, the number of oil feed bores to be provided in the pockets may be minimised.

The oil streams from the two oil supply systems are merged in the plain bearing seal.

It is pointed out that, alternatively, it may be provided that each oil supply system supplies oil to both the feed pocket and also the additional feed pocket.

An embodiment provides that the first oil supply system comprises two axially spaced oil feed bores in the feed pocket, via which oil from the first oil supply system enters the feed pocket. The oil feed bores may be designed so as to be symmetrical to the axial centre of the feed pocket, or asymmetrical. In one embodiment variant, said circumferential groove, which connects the additional feed pocket to the feed pocket, opens into the feed pocket at an axial position which lies between the two oil feed bores of the first oil supply system. This ensures that the oil supplied via the circumferential groove, and the oil already provided to the feed pocket via the first oil supply system, are distributed symmetrically.

A further embodiment provides that the second oil supply system comprises an oil feed bore in the additional feed pocket, which is formed in the additional feed pocket centrally or eccentrically relative to the axial direction of the plain bearing pin, and via which oil from the second oil supply system enters the additional feed pocket and from there passes into the plain bearing gap. The oil feed bore in the additional feed pocket effectively allows heated oil coming from the region with minimal gap height to be displaced in the direction of the axial ends of the plain bearing gap and replaced by fresh cool oil. An embodiment here provides that precisely one oil feed bore is formed in the additional feed pocket and is arranged, with respect to its axial position, centrally between two oil supply bores which are formed in the feed pocket.

The described position of the feed bores in the feed pocket and in the additional feed pocket allows rapid displacement of the hot oil. The circumferential groove between the pockets here ensures that the fresh oil does not heat up between the additional feed pocket and the feed pocket, and flow between the main oil feed bores to the feed pocket. Thus all of the fresh oil is supplied centrally, remains in the gap for a long time and cools the plain bearing pin and planet gear.

A further embodiment provides that two axial grooves are furthermore formed in the plain bearing pin and each extend from the feed pocket in the axial direction to one of the axial ends of the contact face of the plain bearing pin. The axial grooves allow a faster discharge of undesired particles in the lubricating oil. In addition, they ensure a low pocket pressure and reduce an oil flow in the opposite direction.

It may be provided here that the axial grooves have a smaller depth than the feed pocket. If for example the feed pocket has a depth of 3 mm, the axial grooves have for example a depth which is reduced by 50%, in said example 1.5 mm. Similarly, said circumferential groove may also have a smaller depth than the feed pocket and/or the additional feed pocket.

It may furthermore be provided that the feed pocket and the additional feed pocket have the same or a different depth.

A further embodiment provides that the feed pocket in each of the plain bearing pins of the planetary gear box is configured such that it faces radially outward relative to the axial direction of the planetary gear box. The feed pockets thus point radially outward like the digits on a clock face, wherein for a respective plain bearing, the position of the feed pocket in the local coordinate system lies on the 0° angular coordinate in the circumferential direction. In general, the 0° angular degree in the local coordinate system of the plain bearing pin is defined by the radial direction in the coordinate system of the planetary gear box, i.e. at 0°, the radial direction extends radially outward from the plain bearing pin. Alternatively, the feed pockets may be formed in the plain bearing pin offset to the 0° position.

It may furthermore be provided that the feed pocket and the additional feed pocket are formed in the plain bearing pin symmetrically with respect to the axial centre of the plain bearing pin. In particular in the case of asymmetric deformations of the planet gear, it is however also conceivable that the feed pocket and/or the additional feed pocket are formed asymmetrically in the plain bearing pin with respect to the axial centre.

In a further aspect of the invention, the present invention concerns a plain bearing which comprises a first bearing element having a contact face, and a second bearing element having a contact face. The two bearing elements are designed to rotate relative to one another and form a plain bearing gap between their contact faces. On its contact face, the first bearing element forms a feed pocket which is provided and configured to receive oil and output it to the plain bearing.

It is provided that on its contact face, the first bearing element furthermore forms an additional feed pocket which is provided and configured to receive oil and output it to the plain bearing, is spaced from the feed pocket in the circumferential direction and is connected to the feed pocket such that oil from the additional feed pocket can flow on the contact face of the first bearing element to the feed pocket.

The advantages and embodiments presented with respect to the planetary gear box according to the invention also apply accordingly to the plain bearing according to the invention.

The invention also relates to a gas turbine engine for an aircraft, which has:
an engine core comprising a turbine, a compressor, and a turbine shaft connecting the turbine to the compressor;
a fan, which is positioned upstream of the engine core, wherein the fan comprises a plurality of fan blades and is driven by a fan shaft; and
a planetary gear box according to Claim 1, the input of which is connected to the turbine shaft and the output of which is connected to the fan shaft.

One design embodiment in this regard may provide that
the turbine is a first turbine, the compressor is a first compressor, and the turbine shaft is a first turbine shaft;
the engine core further comprises a second turbine, a second compressor, and a second turbine shaft which connects the second turbine to the second compressor; and
the second turbine, the second compressor, and the second turbine shaft are disposed with a view to rotating at a higher rotational speed than the first turbine shaft.

It is pointed out that the present invention is described with reference to a cylindrical coordinate system which has the coordinates x, r, and φ. Here, x indicates the axial direction, r indicates the radial direction, and φ indicates the angle in the circumferential direction. The axial direction here is identical with the engine axis of the gas turbine engine in which the planetary gear box is contained, wherein the axial direction is that from the engine inlet in the direction of the engine outlet. Proceeding from the x-axis, the radial direction points radially outward. Terms such as “in front of”, “behind”, “front”, and “rear” refer to the axial direction, or the flow direction in the engine. Terms such as “outer” or “inner” relate to the radial direction.

As noted elsewhere herein, the present disclosure may relate to a gas turbine engine. Such a gas turbine engine may comprise an engine core which comprises a turbine, a combustion chamber, a compressor, and a core shaft that connects the turbine to the compressor. Such a gas turbine engine may comprise a fan (having fan blades) which is positioned upstream of the engine core.

Arrangements of the present disclosure may be particularly, although not exclusively, beneficial for fans that are driven via a gear box. Accordingly, the gas turbine engine may comprise a transmission that receives an input from the core shaft and outputs drive for the fan so as to drive the fan at a lower rotational speed than the core shaft. The input to the transmission may be performed directly from the core shaft or indirectly from the core shaft, for example via a spur shaft and/or a spur gear. The core shaft may be rigidly connected to the turbine and the compressor, such that the turbine and the compressor rotate at the same rotational speed (wherein the fan rotates at a lower rotational speed).

The gas turbine engine as described and/or claimed herein may have any suitable general architecture. For example, the gas turbine engine may have any desired number of shafts, for example one, two or three shafts, that connect turbines and compressors. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft which connects the second turbine to the second compressor. The second turbine, the second compressor and the second core shaft may be arranged so as to rotate at a higher rotational speed than the first core shaft.

In such an arrangement, the second compressor may be positioned so as to be axially downstream of the first compressor. The second compressor may be arranged so as to receive (for example directly receive, for example via a generally annular duct) flow from the first compressor.

The transmission may be arranged so as to be driven by that core shaft (for example the first core shaft in the example above) which is configured to rotate (for example during use) at the lowest rotational speed. For example, the transmission may be arranged so as to be driven only by the core shaft (for example only by the first core shaft, and not the second core shaft, in the example above) that is configured to rotate (for example during use) at the lowest rotational speed. Alternatively thereto, the transmission may be arranged so as to be driven by one or a plurality of shafts, for example the first and/or the second shaft in the example above.

In the case of a gas turbine engine as described and/or claimed herein, a combustion chamber may be provided axially downstream of the fan and of the compressor(s). For example, the combustion chamber may lie directly downstream of the second compressor (for example at the exit of the latter), when a second compressor is provided. By way of a further example, the flow at the exit of the compressor may be fed to the inlet of the second turbine, when a second turbine is provided. The combustion chamber may be provided upstream of the turbine(s).

The or each compressor (for example the first compressor and the second compressor as described above) may comprise any number of stages, for example multiple stages. Each stage may comprise a row of rotor blades and a row of stator blades, which may be variable stator blades (in the sense that the angle of incidence of said variable stator blades may be variable). The row of rotor blades and the row of stator blades may be axially offset from one another.

The or each turbine (for example the first turbine and the second turbine as described above) may comprise any number of stages, for example multiple stages. Each stage may comprise a row of rotor blades and a row of stator blades. The row of rotor blades and the row of stator blades may be axially offset from one another.

Each fan blade may be defined as having a radial span extending from a root (or a hub) at a radially inner location flowed over by gas, or at a 0% span width position, to a tip at a 100% span width position. The ratio of the radius of the fan blade at the hub to the radius of the fan blade at the tip may be less than (or of the order of magnitude of): 0.4, 0.39, 0.38, 0.37, 0.36, 0.35, 0.34, 0.33, 0.32, 0.31, 0.3, 0.29, 0.28, 0.27, 0.26 or 0.25. The ratio of the radius of the fan blade at the hub to the radius of the fan blade at the tip may be in an inclusive range delimited by two of the values in the previous sentence (that is to say that the values may form upper or lower limits). These ratios can commonly be referred to as the hub-to-tip ratio. The radius at the hub and the radius at the tip can both be measured at the leading periphery part (or the axially frontmost periphery) of the blade. The hub-to-tip ratio refers, of course, to that portion of the fan blade which is flowed over by gas, that is to say the portion that is situated radially outside any platform.

The radius of the fan can be measured between the engine centreline and the tip of the fan blade at the leading periphery of the latter. The diameter of the fan (which can simply be double the radius of the fan) may be larger than (or of the order of magnitude of): 250 cm (approximately 100 inches), 260 cm, 270 cm (approximately 105 inches), 280 cm (approximately 110 inches), 290 cm (approximately 115 inches), 300 cm (approximately 120 inches), 310 cm, 320 cm (approximately 125 inches), 330 cm (approximately 130 inches), 340 cm (approximately 135 inches), 350 cm, 360 cm (approximately 140 inches), 370 cm (approximately 145 inches), 380 cm (approximately 150 inches), or 390 cm (approximately 155 inches). The fan diameter may be in an inclusive range delimited by two of the values in the previous sentence (that is to say that the values may form upper or lower limits).

The rotational speed of the fan may vary during use. Generally, the rotational speed is lower for fans with a comparatively large diameter. Purely by way of a non-limiting example, the rotational speed of the fan under cruise conditions may be less than 2500 rpm, for example less than 2300 rpm. Purely by way of a further non-limiting example, the rotational speed of the fan under cruise conditions for an engine having a fan diameter in the range from 250 cm to 300 cm (for example 250 cm to 280 cm) may also be in the range from 1700 rpm to 2500 rpm, for example in the range from 1800 rpm to 2300 rpm, for example in the range from 1900 rpm to 2100 rpm. Purely by way of a further non-limiting example, the rotational speed of the fan under cruise conditions for an engine having a fan diameter in the range from 320 cm to 380 cm may be in the range from 1200 rpm to 2000 rpm, for example in the range from 1300 rpm to 1800 rpm, for example in the range from 1400 rpm to 1600 rpm.

During use of the gas turbine engine, the fan (with associated fan blades) rotates about an axis of rotation. This rotation results in the tip of the fan blade moving with a velocity Uₜᵢₚ. The work done by the fan blades on the flow results in an enthalpy rise dH in the flow. A fan tip loading can be defined as dH/Uₜᵢₚ², where dH is the enthalpy rise (for example the 1-D average enthalpy rise) across the fan and Uₜᵢₚ is the (translational) velocity of the fan tip, for example at the leading periphery of the tip (which can be defined as the fan tip radius at the leading periphery multiplied by the angular velocity). The fan tip loading at cruise conditions may be more than (or of the order of magnitude of): 0.3, 0.31, 0.32, 0.33, 0.34, 0.35, 0.36, 0.37, 0.38, 0.39, or 0.4 (wherein all units in this passage are Jkg⁻¹K⁻¹/(ms⁻¹)²). The fan tip loading may be in an inclusive range delimited by two of the values in the previous sentence (that is to say that the values may form upper or lower limits).

Gas turbine engines in accordance with the present disclosure may have any desired bypass ratio, wherein the bypass ratio is defined as the ratio of the mass flow rate of the flow through the bypass duct to the mass flow rate of the flow through the core at cruise conditions. In the case of some arrangements, the bypass ratio may be more than (or of the order of magnitude of): 10, 10.5, 11, 11.5, 12, 12.5, 13, 13.5, 14, 14.5, 15, 15.5, 16, 16.5, or 17. The bypass ratio may be in an inclusive range delimited by two of the values in the previous sentence (that is to say that the values may form upper or lower limits). The bypass duct may be substantially annular. The bypass duct may be situated radially outside the engine core. The radially outer surface of the bypass duct may be defined by an engine nacelle and/or a fan casing.

The overall pressure ratio of a gas turbine engine as described and/or claimed herein can be defined as the ratio of the stagnation pressure upstream of the fan to the stagnation pressure at the exit of the highest pressure compressor (before entry into the combustion chamber). By way of a non-limiting example, the overall pressure ratio of a gas turbine engine as described and/or claimed herein at constant speed can be greater than (or of the order of): 35, 40, 45, 50, 55, 60, 65, 70, 75. The overall pressure ratio may be in an inclusive range delimited by two of the values in the previous sentence (that is to say that the values may form upper or lower limits).

The specific thrust of an engine may be defined as the net thrust of the engine divided by the total mass flow through the engine. The specific thrust of an engine as described and/or claimed herein at cruise conditions may be less than (or of the order of magnitude of): 110 Nkg⁻ ¹s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust may be in an inclusive range delimited by two of the values in the previous sentence (that is to say that the values may form upper or lower limits). Such engines can be particularly efficient in comparison with conventional gas turbine engines.

A gas turbine engine as described and/or claimed herein may have any desired maximum thrust. Purely by way of a non-limiting example, a gas turbine as described and/or claimed herein may be capable of generating a maximum thrust of at least (or of the order of magnitude of): 160 kN, 170 kN, 180 kN, 190 kN, 200 kN, 250 kN, 300 kN, 350 kN, 400 kN, 450 kN, 500 kN, or 550 kN. The maximum thrust may be in an inclusive range delimited by two of the values in the previous sentence (that is to say that the values may form upper or lower limits). The thrust referred to above may be the maximum net thrust at standard atmospheric conditions at sea level plus 15° C. (ambient pressure 101.3 kPa, temperature 30° C.) in the case of a static engine.

During use, the temperature of the flow at the entry to the high-pressure turbine can be particularly high. This temperature, which can be referred to as TET, may be measured at the exit to the combustion chamber, for example directly upstream of the first turbine blade, which in turn can be referred to as a nozzle guide vane. At cruising speed, the TET may be at least (or of the order of magnitude of): 1400 K, 1450 K, 1500 K, 1550 K, 1600 K, or 1650 K. The TET at cruising speed may be in an inclusive range delimited by two of the values in the previous sentence (that is to say that the values may form upper or lower limits). The maximum TET in the use of the engine may be at least (or of the order of magnitude of), for example: 1700 K, 1750 K, 1800 K, 1850 K, 1900 K, 1950 K, or 2000 K. The maximum TET may be in an inclusive range delimited by two of the values in the previous sentence (that is to say that the values may form upper or lower limits). The maximum TET may occur, for example, under a high thrust condition, for example under a maximum take-off thrust (MTO) condition.

A fan blade and/or an airfoil portion of a fan blade described and/or claimed herein may be manufactured from any suitable material or a combination of materials. For example, at least a part of the fan blade and/or of the airfoil may be manufactured at least in part from a composite, for example a metal matrix composite and/or an organic matrix composite, such as carbon fibre. By way of a further example, at least a part of the fan blade and/or of the airfoil may be manufactured at least in part from a metal, such as a titanium-based metal or an aluminium-based material (such as an aluminium-lithium alloy) or a steel-based material. The fan blade may comprise at least two regions which are manufactured using different materials. For example, the fan blade may have a protective leading periphery, which is manufactured using a material that is better able to resist impact (for example of birds, ice, or other material) than the rest of the blade. Such a leading periphery may, for example, be manufactured using titanium or a titanium-based alloy. Thus, purely by way of example, the fan blade may have a carbon-fibre-based or aluminium-based body (such as an aluminium-lithium alloy) with a titanium leading periphery.

A fan as described and/or claimed herein may comprise a central portion, from which the fan blades may extend, for example in a radial direction. The fan blades may be attached to the central portion in any desired manner. For example, each fan blade may comprise a fixing device which can engage with a corresponding slot in the hub (or disk). Purely by way of example, such a fixing device may be in the form of a dovetail that can be inserted into and/or engage with a corresponding slot in the hub/disk in order for the fan blade to be fixed to the hub/disk. By way of a further example, the fan blades may be formed integrally with a central portion. Such an arrangement may be referred to as a blisk or a bling. Any suitable method may be used to produce such a blisk or such a bling. For example, at least some of the fan blades may be machined from a block and/or at least some of the fan blades may be attached to the hub/disk by welding, such as linear friction welding, for example.

The gas turbine engines described and/or claimed herein may or may not be provided with a variable area nozzle (VAN). Such a variable area nozzle can allow the exit cross section of the bypass duct to be varied during use. The general principles of the present disclosure can apply to engines with or without a VAN.

The fan of a gas turbine as described and/or claimed herein may have any desired number of fan blades, for example 16, 18, 20 or 22 fan blades.

As used herein, cruise conditions can mean cruise conditions of an aircraft to which the gas turbine engine is attached. Such cruise conditions can be conventionally defined as the conditions at mid-cruise, for example the conditions experienced by the aircraft and/or the engine between (in terms of time and/or distance) the top of climb and the start of descent.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example of the order of Mach 0.8, of the order of Mach 0.85 or in the range of from 0.8 to 0.85. Any arbitrary speed within these ranges can be the constant cruise condition. In the case of some aircraft, the constant cruise conditions may be outside these ranges, for example below Mach 0.7 or above Mach 0.9.

Purely by way of example, the cruise conditions may correspond to standard atmospheric conditions at an altitude that is in the range from 10,000 m to 15,000 m, for example in the range from 10,000 m to 12,000 m, for example in the range from 10,400 m to 11,600 m (around 38,000 ft), for example in the range from 10,500 m to 11,500 m, for example in the range from 10,600 m to 11,400 m, for example in the range from 10,700 m (around 35,000 ft) to 11,300 m, for example in the range from 10,800 m to 11,200 m, for example in the range from 10,900 m to 11,100 m, for example of the order of 11,000 m. The cruise conditions may correspond to standard atmospheric conditions at any given altitude in these ranges.

Purely by way of example, the cruise conditions may correspond to the following: a forward Mach number of 0.8; a pressure of 23,000 Pa; and a temperature of -55° C.

As used anywhere herein, “cruising speed” or “cruise conditions” may mean the aerodynamic design point. Such an aerodynamic design point (or ADP) may correspond to the conditions (including, for example, the Mach number, environmental conditions, and thrust requirement) for which the fan operation is designed. This may mean, for example, the conditions under which the fan (or the gas turbine engine) has the optimum efficiency in terms of construction.

In use, a gas turbine engine described and/or claimed herein can operate at the cruise conditions defined elsewhere herein. Such cruise conditions may be determined by the cruise conditions (for example the conditions during the middle part of the flight) of an aircraft to which at least one (for example 2 or 4) gas turbine engine(s) can be fastened in order to provide thrust force.

It is self-evident to a person skilled in the art that a feature or parameter described in relation to one of the above aspects may be applied to any other aspect, unless these are mutually exclusive. Furthermore, any feature or any parameter described here may be applied to any aspect and/or combined with any other feature or parameter described here, unless these are mutually exclusive.

The invention will be explained in more detail below on the basis of a plurality of exemplary embodiments with reference to the figures of the drawing. In the drawings:

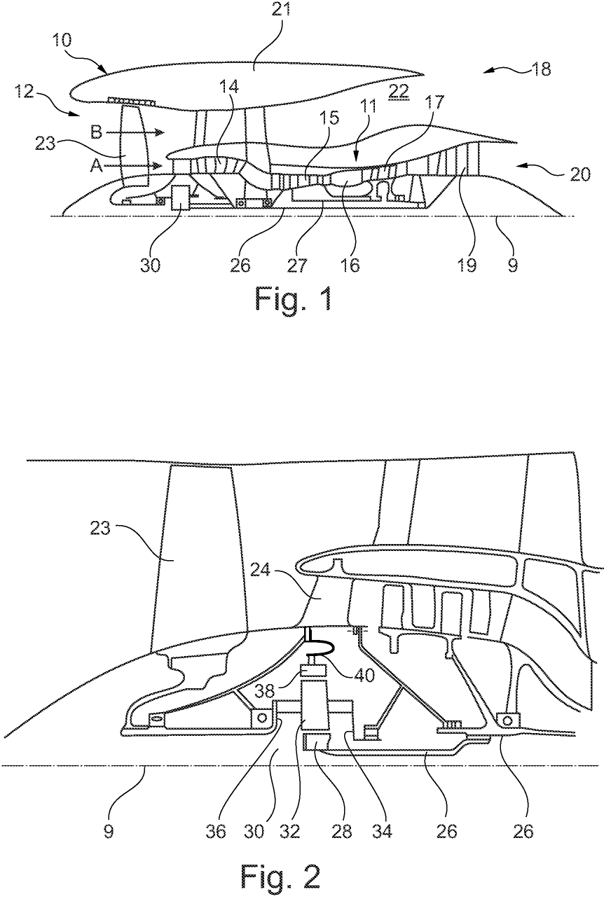

FIG. 1 shows a lateral sectional view of a gas turbine engine;

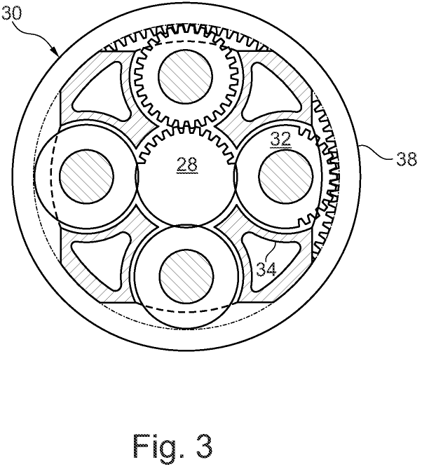

FIG. 2 shows a close-up lateral sectional view of an upstream portion of a gas turbine engine;

FIG. 3 shows a partially cut-away view of a gear box for a gas turbine engine;

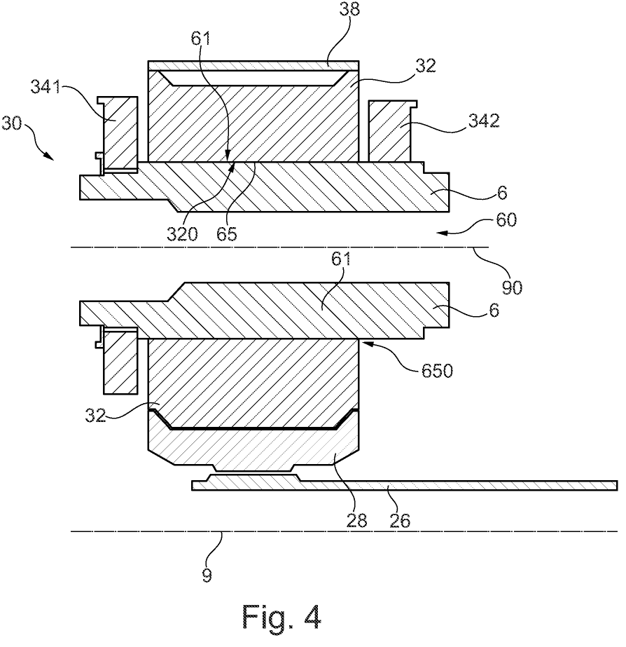

FIG. 4 shows a sectional illustration of the elements of a planetary gear box which is suitable for use in a gas turbine engine as shown in FIG. 1;

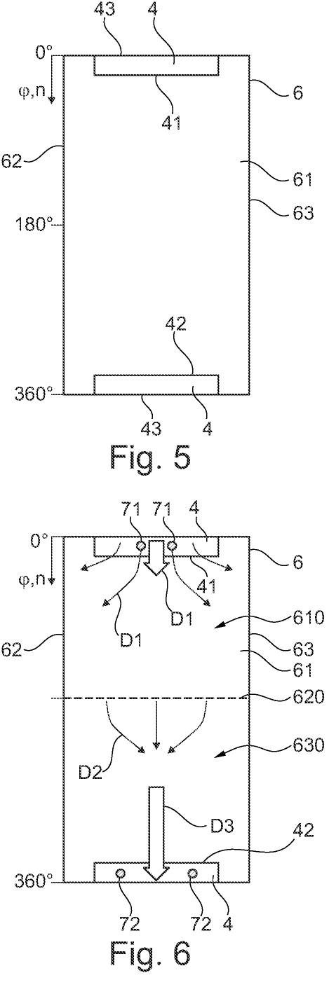

FIG. 5 shows a plain bearing pin having a feed pocket according to the prior art, wherein the illustration is selected so as to show the unrolled outer face of the plain bearing pin;

FIG. 6 shows the plain bearing pin from FIG. 5 with additional depiction of the flow of lubricating oil in the plain bearing gap during operation;

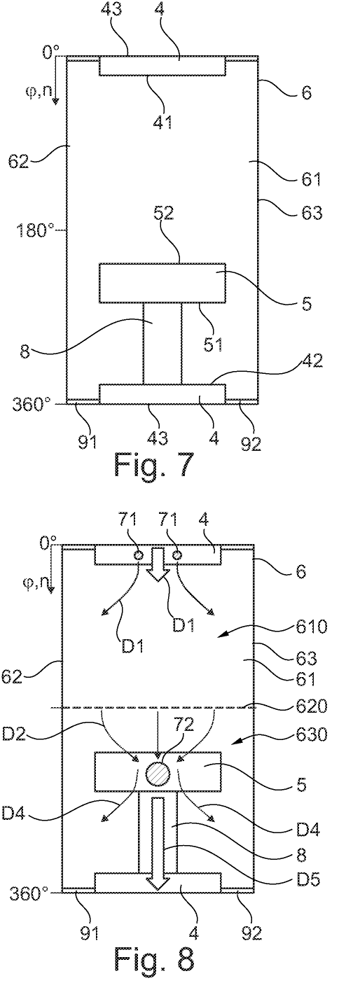

FIG. 7 shows an exemplary embodiment of a plain bearing pin comprising a feed pocket and an additional feed pocket which are spaced apart from one another in the circumferential direction, wherein the illustration is selected so as to show the unrolled outer face of the plain bearing pin; and

FIG. 8 shows the plain bearing pin from FIG. 7 with additional depiction of the flow of lubricating oil in the plain bearing gap during operation.

FIG. 1 illustrates a gas turbine engine 10 having a main axis of rotation 9. The engine 10 comprises an air intake 12 and a thrust fan 23 that generates two air flows: a core air flow A and a bypass air flow B. The gas turbine engine 10 comprises a core 11 which receives the core air flow A. In the sequence of axial flow, the engine core 11 comprises a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass air flow B flows through the bypass duct 22. The fan 23 is attached to and driven by the low-pressure turbine 19 by way of a shaft 26 and an epicyclic transmission 30.

During use, the core air flow A is accelerated and compressed by the low-pressure compressor 14 and directed into the high-pressure compressor 15, where further compression takes place. The compressed air expelled from the high-pressure compressor 15 is directed into the combustion device 16, where it is mixed with fuel and the mixture is combusted. The resulting hot combustion products then propagate through the high-pressure and the low-pressure turbines 17, 19 and thereby drive said turbines, before being expelled through the nozzle 20 to provide a certain propulsive thrust. The high-pressure turbine 17 drives the high-pressure compressor 15 by means of a suitable connecting shaft 27. The fan 23 generally provides the major part of the thrust force. The epicyclic gear box 30 is a reduction gear box.

An exemplary arrangement for a geared fan gas turbine engine 10 is shown in FIG. 2. The low-pressure turbine 19 (see FIG. 1) drives the shaft 26, which is coupled to a sun gear 28 of the epicyclic gear box assembly 30. Multiple planet gears 32, which are coupled to one another by a planet carrier 34, are situated radially to the outside of the sun gear 28 and mesh therewith. The planet carrier 34 limits the planet gears 32 to orbiting around the sun gear 28 in a synchronous manner while enabling each planet gear 32 to rotate about its own axis. The planet carrier 34 is coupled by way of linkages 36 to the fan 23 so as to drive the rotation of the latter about the engine axis 9. Radially to the outside of the planet gears 32 and meshing therewith is an annulus or ring gear 38 that is coupled, via linkages 40, to a stationary support structure 24.

It is noted that the terms “low-pressure turbine” and “low-pressure compressor” as used herein can be taken to mean the lowest pressure turbine stage and the lowest pressure compressor stage (that is to say not including the fan 23) respectively and/or the turbine and compressor stages that are connected to one another by the connecting shaft 26 with the lowest rotational speed in the engine (that is to say not including the transmission output shaft that drives the fan 23). In some documents, the “low-pressure turbine” and the “low-pressure compressor” referred to herein may alternatively be known as the “intermediate-pressure turbine” and “intermediate-pressure compressor”. Where such alternative nomenclature is used, the fan 23 can be referred to as a first compression stage or lowest-pressure compression stage.

The epicyclic gear box 30 is shown in an exemplary manner in greater detail in FIG. 3. Each of the sun gear 28, the planet gears 32 and the ring gear 38 comprise teeth about their periphery to mesh with the other gears. However, for clarity, only exemplary portions of the teeth are illustrated in FIG. 3. Although four planet gears 32 are illustrated, it will be apparent to a person skilled in the art that more or fewer planet gears 32 may be provided within the scope of protection of the claimed invention. Practical applications of an epicyclic transmission 30 generally comprise at least three planet gears 32.

The epicyclic gear box 30 illustrated by way of example in FIGS. 2 and 3 is a planetary gear box, in which the planet carrier 34 is coupled to an output shaft via linkages 36, wherein the ring gear 38 is fixed. However, any other suitable type of epicyclic gear box 30 can be used. By way of further example, the epicyclic gear box 30 can be a star arrangement, in which the planet carrier 34 is held so as to be fixed, wherein the ring gear (or annulus) 38 is allowed to rotate. In the case of such an arrangement, the fan 23 is driven by the ring gear 38. As a further alternative example, the gear box 30 can be a differential gear in which both the ring gear 38 and the planet carrier 34 are allowed to rotate.

It is self-evident that the arrangement shown in FIGS. 2 and 3 is merely an example, and various alternatives fall within the scope of protection of the present disclosure. Purely by way of example, any suitable arrangement can be used for positioning the gear box 30 in the engine 10 and/or for connecting the gear box 30 to the engine 10. By way of a further example, the connections (such as the linkages 36, 40 in the example of FIG. 2) between the gear box 30 and other parts of the engine 10 (such as the input shaft 26, the output shaft and the fixed structure 24) may have a certain degree of stiffness or flexibility. By way of a further example, any suitable arrangement of the bearings between rotating and stationary parts of the engine (for example between the input and output shafts of the gear box and the fixed structures, such as the gear box housing) may be used, and the disclosure is not limited to the exemplary arrangement of FIG. 2. For example, where the gear box 30 has a star arrangement (described above), the person skilled in the art would readily understand that the arrangement of output and support linkages and bearing positions would typically be different to that shown by way of example in FIG. 2.

Accordingly, the present disclosure extends to a gas turbine engine having an arbitrary arrangement of gear box types (for example star-shaped or planetary), support structures, input and output shaft arrangement, and bearing positions.

Optionally, the gear box may drive additional and/or alternative components (e.g. the intermediate-pressure compressor and/or a booster compressor).

Other gas turbine engines in which the present disclosure can be used may have alternative configurations. For example, such engines may have an alternative number of compressors and/or turbines and/or an alternative number of connecting shafts. By way of a further example, the gas turbine engine shown in FIG. 1 has a split flow nozzle 20, 22, meaning that the flow through the bypass duct 22 has its own nozzle that is separate from and radially outside the core engine nozzle 20. However, this is not restrictive, and any aspect of the present disclosure can also apply to engines in which the flow through the bypass duct 22 and the flow through the core 11 are mixed or combined before (or upstream of) a single nozzle, which may be referred to as a mixed flow nozzle. One or both nozzles (whether mixed or split flow) can have a fixed or variable region. Although the example described relates to a turbofan engine, the disclosure can be applied, for example, to any type of gas turbine engine, such as, for example, an open rotor engine (in which the fan stage is not surrounded by an engine nacelle) or a turboprop engine. In some arrangements, the gas turbine engine 10 possibly does not comprise a gear box 30.

The geometry of the gas turbine engine 10, and components thereof, is/are defined by a conventional axis system, which comprises an axial direction (which is aligned with the axis of rotation 9), a radial direction (in the direction from bottom to top in FIG. 1), and a circumferential direction (perpendicular to the view in FIG. 1). The axial, radial and circumferential directions are mutually perpendicular.

For better understanding of the background of the invention, a planetary gear box known from the prior art is explained in more detail with reference to FIG. 4. FIG. 4 shows a sectional illustration of an exemplary embodiment of a planetary gear box 30 of a gas turbine engine designed as a geared fan engine as shown in FIG. 1. The planetary gear box 30 comprises a sun gear 28, which is driven by a drive shaft 26 or sun shaft. The drive shaft 26 is the shaft 26 in FIGS. 1 and 2 or, more generally, a turbine shaft. In this arrangement, the sun gear 28 and the drive shaft 26 rotate around the axis of rotation 9. The axis of rotation of the planetary gear box 30 is identical with the axis of rotation 9 or engine axis of the gas turbine engine 10.

The planetary gear box 30 furthermore comprises a plurality of planet gears 32, one of which is illustrated in the sectional illustration in FIG. 4. The sun gear 28 drives the plurality of planet gears 32, wherein a toothing of the sun gear 28 is in engagement with a toothing of the planet gear 32.

The planet gear 32 is of hollow cylindrical design and forms an outer lateral surface and an inner lateral surface. Driven by the sun gear 28, the planet gear 32 rotates around an axis of rotation 90, which is parallel to the axis of rotation 9. The outer circumferential surface of the planet gear 32 forms a toothing, which is in engagement with the toothing of a ring gear 38. The ring gear 38 is arranged in a fixed manner, i.e. in such a way that it does not rotate. However, attention is drawn to the fact that the present invention is not restricted to planetary gear boxes with a stationary ring gear. It can likewise be implemented in planetary gear boxes with a stationary planet carrier and a rotating ring gear.

Owing to their coupling with the sun gear 28, the planet gears 32 rotate and, in so doing, move along the circumference of the ring gear 38. The rotation of the planet gears 32 along the circumference of the ring gear 38 and simultaneously around the axis of rotation 90 is slower than the rotation of the drive shaft 26, thereby providing a reduction ratio.

Adjoining its inner lateral surface, the planet gear 32 has a centred axial opening. A plain bearing pin 6, which itself also has an axial bore 60, is introduced into the opening, wherein the longitudinal axis of the bore is identical to the axis of rotation 90 of the planet gear 32. The plain bearing pin 6 and the planet gear 32 form a plain bearing 65 at their mutually facing surfaces. The plain bearing pin 6 is also called a planet pin, planet gear pin or planet gear bearing pin.

The mutually facing surfaces of the plain bearing pin 6 and the planet gear 32 are an at least approximately cylindrical, external contact face or outer face 61 of the plain bearing pin 6 and an at least approximately cylindrical inner face 320 of the planet gear 32. These surfaces form the running surfaces of the plain bearing. Lubricating oil is present between the running surfaces 61, 320, and on rotation builds up a hydrodynamic lubricant film which separates the running surfaces from one another. Here the plain bearing forms a plain bearing gap 650 between the running surfaces 61, 320. The height of the plain bearing gap 650, which is a radial height, varies in the circumferential direction, as will be explained in more detail below with reference to FIGS. 5 to 8. The height of the plain bearing gap 650 defines the lubricant film thickness of the oil. The smaller the lubricant film thickness, the greater the lubricant film pressure and the greater the temperature development in the lubricant film or oil.

It is pointed out that the plain bearing pin 6 may have numerous designs. Its outer face 61 may be cylindrical or alternatively spherical, as described in US 2019/162294 A1. The axial bore 60 of the plain bearing pin 6 may be hollow cylindrical or alternatively have an inner diameter which varies over the axial length, as also described in US 2019/162294 A1. It is also conceivable that the plain bearing pin 6 for example has a stiffness which varies over its axial length, for example by means of different wall thicknesses, as described in US 2021/025477 A1. Moreover, the design of the plain bearing pin 6 with an axial bore 60 should be considered merely exemplary. It may alternatively be provided that the plain bearing pin 6 has no axial bore and is solid. Furthermore, embodiment variants may be provided in which the plain bearing pin is structured in the radial direction, for example comprises a main body and a plain bearing ring which is radially spaced from the main body, forming the plain bearing 65 together with the planet gear 32.

FIG. 4 furthermore shows a front carrier plate 341 and a rear carrier plate 342, which are constituent parts of the planet carrier 34, cf. FIG. 2. The planet pin 6 is fixedly connected to the front carrier plate 341 and to the rear carrier plate 342. The front carrier plate 341 is for example connected to a torque-transmitting member, which is coupled to a fan shaft.

To lubricate the bearing 65 between the plain bearing pin 6 and the planet gear 32, one or more oil supply systems are provided, which comprise oil feed channels (not shown) which each terminate in an oil feed pocket (not shown) formed on or machined into the outer contact face 61 of the plain bearing pin 6. Oil from a circulating oil system is conducted into the feed pockets in the plain bearing pin 6 via the oil feed channels. The oil is supplied for example via the axial inner bore 60 of the plain bearing pin 6.

In the context of the present invention, the provision of effective cooling of the plain bearing gap is of importance. The principles of the present invention have been described with reference to plain bearings in a planetary gear box of a gas turbine engine, but in principle however also apply to plain bearings in any gear boxes.

Before the invention is explained with reference to an exemplary embodiment shown in FIGS. 7 and 8, for better understanding of the background of the invention, initially a plain bearing pin known from the prior art is presented with reference to FIGS. 5 and 6.

FIG. 5 shows the contact face 61 of a plain bearing pin 6 in an unrolled illustration. The angular degree φ in the circumferential direction is shown at the left-hand edge. The contact face 61 has a depression which forms a feed pocket 4 for oil from an oil supply system. In the exemplary embodiment shown, the feed pocket 4 is rectangular and formed in the plain bearing pin 6 symmetrically with respect to its axial centre.

In general, the 0° angular degree in the local coordinate system of the plain bearing pin 6 is defined by the radial direction in the coordinate system of the planetary gear box, i.e. at 0°, the radial direction extends effectively radially outward from the plain bearing pin 6. In the exemplary embodiment illustrated, the feed pocket 4 is positioned such that the position of its centre line lies on the 0° angular degree. However, this is not necessarily the case. The rotational direction n in which the angle is measured corresponds to the rotational direction of the planet gear which rotates on the plain bearing pin 6.

The feed pocket 4 may for example be configured such that its maximum depth in the axial direction is constant along the centre line 43, and at its long sides 41, 42, which are spaced apart in the circumferential direction, it transforms smoothly and without edges into the contact face 61.

The contact face 61 comprises an axially front end face 62 and an axially rear end face 63. It is pointed out that the end face of the plain bearing pin 6 need not correspond to the axial positions of the end faces 62, 63 of the contact face 61.In particular, according to FIG. 4, it may be provided that the plain bearing pin 6 forms end regions which extend axially to the front and axially to the rear beyond the plain bearing 65, and connect the plain bearing pin 6 to a front carrier plate and a rear carrier plate of a planet carrier.

FIG. 6 shows the plain bearing pin 6 from FIG. 5 in operation, when a plain bearing 65 according to FIG. 4 is formed between the contact face 61 and an associated contact face of a planet gear. FIG. 6 also shows oil feed bores 71, 72 from two oil supply systems, which terminate in and supply oil to the feed pocket 4. For safety reasons, in order to create redundancy, two independent oil supply systems are provided.

FIG. 6 furthermore shows the flow of oil in the plain bearing gap or on the contact face 61.The gap height of the plain bearing gap here varies in the circumferential direction. This is because, during operation of the planetary gear box, because of the rotational movement of the planet gears and the interaction between the toothing of the planet gear and the ring gear, the acting load reaches a maximum at a specific circumferential angle φ. Accordingly, adjacent to the 0° position in the circumferential direction, the plain bearing gap forms a convergent region 610, a minimal gap height 620 which corresponds to the maximum acting load, and a divergent region 630, wherein the minimal gap height 620 - in the exemplary embodiment illustrated, but not necessarily - lies at around 170°. Depending on the position to which the maximum of the external load points, the angular coordinate of the minimal gap height 620 may vary, for example over a range of 40°.

According to FIG. 6, fresh oil flows along the arrows D1 from the feed pocket 4 into the convergent region 610, and is heated there as far as the minimal gap height 620. The maximum oil temperature is reached at the minimal gap height 620. In the adjacent divergent region 630 of the plain bearing gap, the oil collects along arrows D2 into an oil stream D3 which runs centrally and opens into the feed pocket 4. This is however disadvantageous, since the heated oil heats the adjacent components, i.e. the plain bearing pin 6 and the planet gear. In addition, its backflow to the feed pocket 4 prevents the inflow of fresh oil into the feed pocket 4.

FIG. 7 shows an exemplary embodiment of a plain bearing pin 6 with a contact face 61 in an unrolled illustration. Insofar as the plain bearing pin 6 corresponds to the plain bearing pin of FIGS. 5 and 6, reference is made to the statements concerning these. The plain bearing pin 6 from FIG. 7 differs from the plain bearing pin of FIGS. 5 and 6 in that, in addition to the feed pocket 4, a further feed pocket, called the additional feed pocket 5, is provided. Like the feed pocket 4, this is also provided to receive oil from an oil supply system and output it to the plain bearing. The additional feed pocket 5 is spaced apart from the feed pocket 4 in the circumferential direction. The additional feed pocket 5 and the feed pocket 4 are connected together via a circumferential groove 8 extending in the circumferential direction. The angular spacing between the feed pocket 4 and the additional feed pocket 5 in some embodiments is at least 90°.

In the unrolled illustration, the additional feed pocket 5 is rectangular with two long sides 51, 52 spaced apart from one another in the circumferential direction. It is formed for example such that its maximal depth in the axial direction is constant along the centre line 43, and at its long sides 51, 52, it transforms smoothly and without edges into the contact face 61.

In the exemplary embodiment illustrated, the additional feed pocket has the same axial length and same width in the circumferential direction as the feed pocket 4. This is however to be understood merely as an example. The additional feed pocket 5 and the feed pocket 4 may alternatively differ with respect to these and other parameters.

The feed pocket 4 and the additional feed pocket 5 are arranged parallel to one another.

The plain bearing pin of FIG. 7 differs from the plain bearing pin of FIGS. 5 and 6 furthermore by the formation of two axial grooves 91, 92, which each extend from the feed pocket 4 to the respective adjacent end face 62, 63 of the contact face 61.The axial grooves 91, 92 serve for improved axial discharge of dirt particles present in the lubricating oil.

FIG. 8 shows an illustration of the plain bearing pin 6 from FIG. 7 which, like FIG. 6, additionally shows the flow of oil and the oil feed bores. It is provided that the oil feed bores 71 of a first oil supply system terminate in and supply oil to the feed pocket 4. Two oil feed bores 71 are provided, which are spaced apart from one another in the axial direction. An oil feed bore 72 of a second oil supply system terminates in the additional oil feed pocket 5 and is arranged centrally therein. It is thus provided that the two oil supply systems each supply oil to only one of the pockets 4, 5. This is however to be understood merely as an example.

The two oil feed bores 71 of the feed pocket 4 are positioned in the feed pocket 4 such that the circumferential groove 8 opens into the feed pocket 4 at an axial position which lies between these two oil feed bores 71. It may be provided that the circumferential groove 8 runs in the axial centre of the plain bearing pin 6. It may however, alternatively, run offset to the axial centre.

FIG. 8 furthermore shows that the position of the additional feed pocket 6 in the circumferential direction is selected such that it lies behind the minimal gap height 620 in the divergent region 630. It may be provided that the distance in the circumferential direction is 40° to 60° behind the greatest circumferential angle in the plain bearing pin 6 which forms a minimal gap height. It is pointed out that the position of the minimal gap height 620 in the circumferential direction may vary depending on operating conditions, so that the greatest angle at which the gap height is minimal is considered with respect to said distance.

The oil flow in the plain bearing pin 6 of FIGS. 7 and 8 is such that, initially, fresh oil flows along arrows D1 from the feed pocket 4 into the convergent region 610 of the plain bearing gap and is heated there as far as the minimal gap height 620. The maximum oil temperature is reached at the minimal gap height 620. In the adjacent divergent region 630 of the plain bearing gap, the oil collects along arrows D2 centrally over an only short circumferential region, and is then displaced by the fresh oil from the additional feed pocket 5, emerging via the oil feed bore 72, and discharged in the axial direction along arrows D4 to the two axial end faces. Thus the plain bearing pin 6 and planet gear are only heated to a reduced extent. Oil is also prevented from flowing back into the feed pocket 4. At the same time, cooling is provided by the fresh oil from the additional feed pocket 5.

The cool oil entering the additional feed pocket 5 is conducted into the additional pocket 4 via the circumferential groove 8 without undergoing substantial heating. The circumferential groove 8 here minimises a heat development in the oil which is attributable to shear forces. In the additional pocket 4, the oil stream D5 from the additional feed pocket 5 mixes with fresh oil supplied via the oil feed bores 71. Thus very cool oil is transported along arrows D1 in the direction of the convergent region 610.

The additional feed pocket 5 thus ensures that hot oil in the divergent region of the plain bearing gap is rapidly transported to the axial ends and replaced by cool oil from the additional feed pocket.

The invention is not restricted to the present exemplary embodiments which should be regarded as merely exemplary. It is in particular pointed out that any of the features described may be used separately or in combination with any other features, unless they are mutually exclusive. The disclosure extends to and comprises all combinations and sub-combinations of one or a plurality of features which are described here. If ranges are defined, said ranges thus comprise all of the values within said ranges as well as all of the partial ranges that lie in a range.

1. Planetary gear box, which has:
a sun gear, which is rotatable about an axis of rotation of the planetary gear box and defines an axial direction of the planetary gear box,
a plurality of planet gears, which are driven by the sun gear,
a ring gear, with which the plurality of planet gears is in engagement,
a plurality of plain bearing pins which each have an external contact face, wherein
a plain bearing pin is arranged in each planet gear, wherein the plain bearing pin and the planet gear form a lubricated plain bearing which comprises a plain bearing gap, and
on its contact face, the plain bearing pin forms a feed pocket which is provided and configured to receive oil and output it to the plain bearing, wherein
on its contact face, the plain bearing pin furthermore forms an additional feed pocket which
is provided and configured to receive oil and output it to the plain bearing,
is spaced from the feed pocket in the circumferential direction, and
is connected to the feed pocket such that oil from the additional feed pocket can flow on the contact face of the plain bearing pin to the feed pocket.

2. Planetary gear box according to claim 1, wherein in operation, in the circumferential direction, the plain bearing gap comprises a convergent region, a minimal gap height and a divergent region, wherein the additional feed pocket is formed in the divergent region of the plain bearing gap.

3. Planetary gear box according to claim 2, wherein the additional feed pocket is formed in the plain bearing pin in the divergent region of the plain bearing gap in an angular region between 40° and 60° behind the greatest circumferential angle which corresponds to a minimal gap height.

4. Planetary gear box according to claim 2, wherein the feed pocket is formed in the plain bearing pin in the transition between the divergent region and the convergent region.

5. Planetary gear box according to claim 1, wherein the additional feed pocket is connected to the feed pocket via a circumferential groove extending in the circumferential direction.

6. Planetary gear box according to claim 1, wherein the feed pocket and/or the additional feed pocket are formed so as to be rectangular in an unrolled view from above.

7. Planetary gear box according to claim 1, wherein the feed pocket and/or the additional feed pocket are formed centrally in the plain bearing pin with respect to the axial length of the plain bearing pin.

8. Planetary gear box according to claim 1, wherein the feed pocket and the additional feed pocket have the same axial length.

9. Planetary gear box according to claim 1, wherein the feed pocket and the additional feed pocket have the same width in the circumferential direction.

10. Planetary gear box according to claim 1, wherein the feed pocket and the additional feed pocket have an axial length which corresponds to at least 50% of the axial length of the plain bearing gap.

11. Planetary gear box according to claim 1, wherein the planetary gear box has a first and a second oil supply system for the provision of lubricating oil, which are independent of one another, wherein the first oil supply system supplies oil to the feed pocket and the second oil supply system supplies oil to the additional feed pocket.

12. Planetary gear box according to claim 11, wherein the first oil supply system comprises two axially spaced oil feed bores in the feed pocket, which are provided and configured such that oil from the first oil supply system enters the feed pocket via said bores.

13. Planetary gear box according to claim 12, wherein the circumferential groove opens into the feed pocket at an axial position which lies between the two oil feed bores of the first oil supply system.

14. Planetary gear box according to claim 11, wherein the second oil supply system forms an oil feed bore in the additional feed pocket, which is provided and configured such that oil from the second oil supply system enters the additional feed pocket via said bore.

15. Planetary gear box according to claim 1, wherein two axial grooves are furthermore formed in the plain bearing pin and each extend from the feed pocket to a respective one of the axial ends of the contact face.

16. Planetary gear box according to claim 15, wherein the axial grooves have a smaller depth than the feed pocket.

17. Planetary gear box according to claim 1, wherein the feed pocket in each of the plain bearing pins of the planetary gear box is configured such that it faces radially outward relative to the axial direction of the planetary gear box.

18. Planetary gear box according to claim 1, wherein the feed pocket and the additional feed pocket are formed in the plain bearing pin symmetrically with respect to the axial centre of the plain bearing pin.

19. Plain bearing which comprises:
a first bearing element having a contact face,
a second bearing element having a contact face, wherein
the two bearing elements are configured to rotate relative to one another and form a plain bearing gap between their contact faces, and
on its contact face, the first bearing element forms a feed pocket which is provided and configured to receive oil and output it to the plain bearing, wherein
on its contact face, the first bearing element furthermore forms an additional feed pocket which
is provided and configured to receive oil and output it to the plain bearing,
is spaced from the feed pocket in the circumferential direction, and
is connected to the feed pocket such that oil from the additional feed pocket can flow on the contact face of the first bearing element to the feed pocket.

20. Gas turbine engine for an aircraft, which has:
an engine core comprising a turbine, a compressor, and a turbine shaft connecting the turbine to the compressor;
a fan, which is positioned upstream of the engine core, wherein the fan comprises a plurality of fan blades and is driven by a fan shaft; and
a planetary gear box according to claim 1, the input of which is connected to the turbine shaft and the output of which is connected to the fan shaft.
